(19) United States
(12) Patent Application Publication
(10) Pub. No.: US 2023/0399222 A1
(43) Pub. Date: Dec. 14, 2023

(54) HOUSEHOLD APPLIANCE DISPENSER CUSTOMIZATION

(71) Applicant: Haier US Appliance Solutions, Inc., Wilmington, DE (US)

(72) Inventors: Matthew R. Hunter, Louisville, KY (US); Megan Etgen, Louisville, KY (US); Gregory Sergeevich Chernov, Louisville, KY (US); Brent Alden Junge, Louisville, KY (US)

(21) Appl. No.: 17/836,411

(22) Filed: Jun. 9, 2022

(51) Int. Cl. B67D 1/12; B67D 1/08; F25C 5/20

(52) U.S. Cl. CPC B67D 1/12; B67D 1/0895; F25C 5/22; F25C 2400/10; F25C 2400/14; F25C 2700/00

(57) ABSTRACT

A method of operating a dispenser system of a refrigerator appliance includes storing a custom dispenser setting for the dispenser system. The method may also include recognizing a user at the refrigerator appliance or receiving an input with the dispenser system and determining a time when the input is received. The method then includes applying the custom dispenser setting. The custom dispenser setting may be applied based on the recognized user and/or the determined time. The method further includes dispensing one or more objects from the dispenser system according to the applied custom dispenser setting.

### FIELD OF THE INVENTION

The present subject matter relates generally to household appliances, and more particularly to such appliances which include dispenser systems and methods of operating such dispenser systems.

### BACKGROUND OF THE INVENTION

Various household appliances include dispenser systems, such as refrigerator appliances, ice maker appliances, water cooler appliances, and beverage systems.

Refrigerator appliances generally include a cabinet that defines a chilled chamber. A wide variety of food items may be stored within the chilled chamber. The low temperature of the chilled chamber relative to ambient atmosphere assists with increasing a shelf life of the food items stored within the chilled chamber.

Refrigerator appliances may also be equipped with a dispenser system. Such dispenser systems typically provide chilled water and/or ice from inside of the refrigerator appliance to a dispensing outlet accessible from outside of the refrigerator appliance. Such dispensing outlets are typically provided in an external surface of a door of the refrigerator appliance, in order to provide access to the water and/or ice from inside of the refrigerator appliance without requiring opening the door.

Some dispenser systems, e.g., in a refrigerator appliance or other similar household appliance, e.g., ice maker appliance or water cooler appliance, etc., may also provide numerous selectable options, such as a selectable water temperature, e.g., chilled or heated, a selectable ice type, e.g., cubed or crushed, and may also provide additional selectable options such as other beverages in addition to water, e.g., juice, carbonated beverages, etc. Such increased choices and customization are desirable for consumers, but may also result in a more complex user interface and/or multiple steps required to select one particular option out of the multiple selectable options available.

Accordingly, a household appliance with an improved dispenser system is desired. For example, a household appliance with features for providing streamlined or pre-selected customized dispensing and related methods would be useful.

### BRIEF DESCRIPTION OF THE INVENTION

Aspects and advantages of the invention will be set forth in part in the following description, or may be apparent from the description, or may be learned through practice of the invention.

In one exemplary embodiment, a method of operating a dispenser system of a household appliance is provided. The method includes storing a custom dispenser setting for the dispenser system. The method also includes recognizing a user at the household appliance and applying the custom dispenser setting based on the recognized user. The method further includes dispensing one or more objects from the dispenser system according to the applied custom dispenser setting.

In another exemplary embodiment, a method of operating a dispenser system of a household appliance is provided. The method includes storing a custom dispenser setting for the dispenser system. The method also includes receiving an input with the dispenser system and determining a time when the input is received. The method further includes applying the custom dispenser setting based on the determined time. The method also includes dispensing one or more objects from the dispenser system according to the applied custom dispenser setting.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary household appliance, e.g., a refrigerator appliance, according to an exemplary embodiment of the present subject matter.

FIG. 2 provides a perspective view of the refrigerator appliance of FIG. 1.

FIG. 3 provides a front view of the refrigerator appliance of FIG. 1 with doors in an open position.

FIG. 4 provides a schematic illustration of an example sealed cooling system as may be used with a refrigerator appliance in one or more exemplary embodiments of the present subject matter.

FIG. 5 provides a schematic diagram of a dispenser system for a household appliance according to one or more exemplary embodiments of the present subject matter.

FIG. 6 provides a flow diagram of an exemplary method for operating a dispenser system of a household appliance according to one or more exemplary embodiments of the present subject matter.

FIG. 7 provides a flow diagram of an additional exemplary method for operating a dispenser system of a household appliance according to one or more exemplary embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. Terms such as “inner” and “outer” refer to relative directions with respect to the interior and exterior of the refrigerator appliance, and in particular the food storage chamber(s) defined therein. For example, “inner” or “inward” refers to the direction towards the interior of the refrigerator appliance. Terms such as “left,” “right,” “front,” “back,” “top,” or “bottom” are used with reference to the perspective of a user accessing the refrigerator appliance. For example, a user stands in front of the refrigerator to open the doors and reaches into the food storage chamber(s) to access items therein.

As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The present subject matter is generally related to any household appliance having a dispenser system. For example, the household appliance may be a refrigerator appliance, such as the exemplary refrigerator appliance illustrated in the accompanying FIGS., or may be any other suitable household appliance with a dispenser system, such as an ice maker appliance, a water cooler appliance, or a beverage dispensing system, among other possibilities.

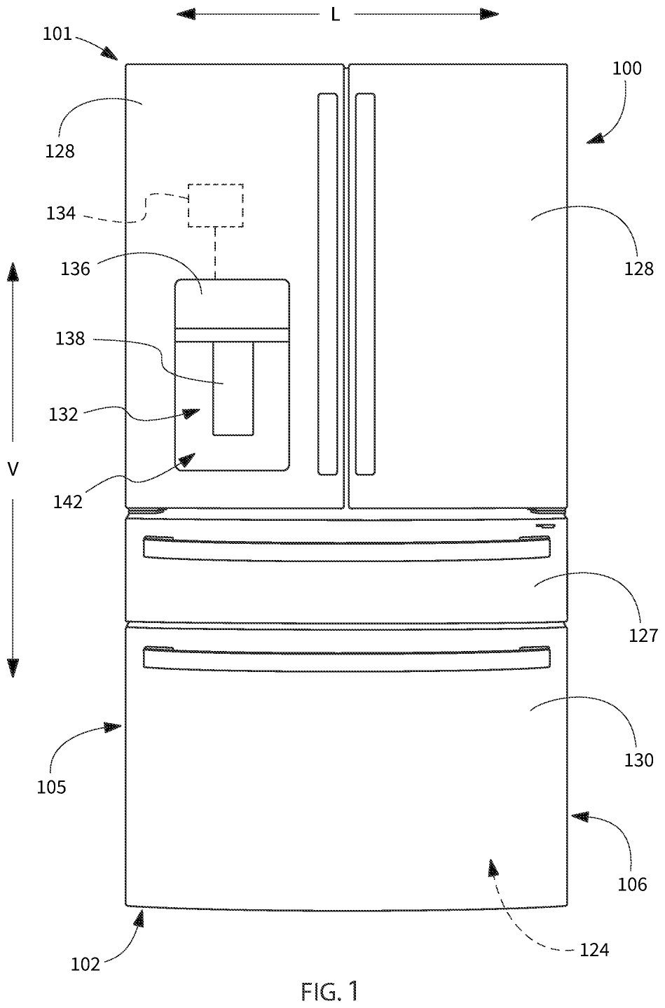

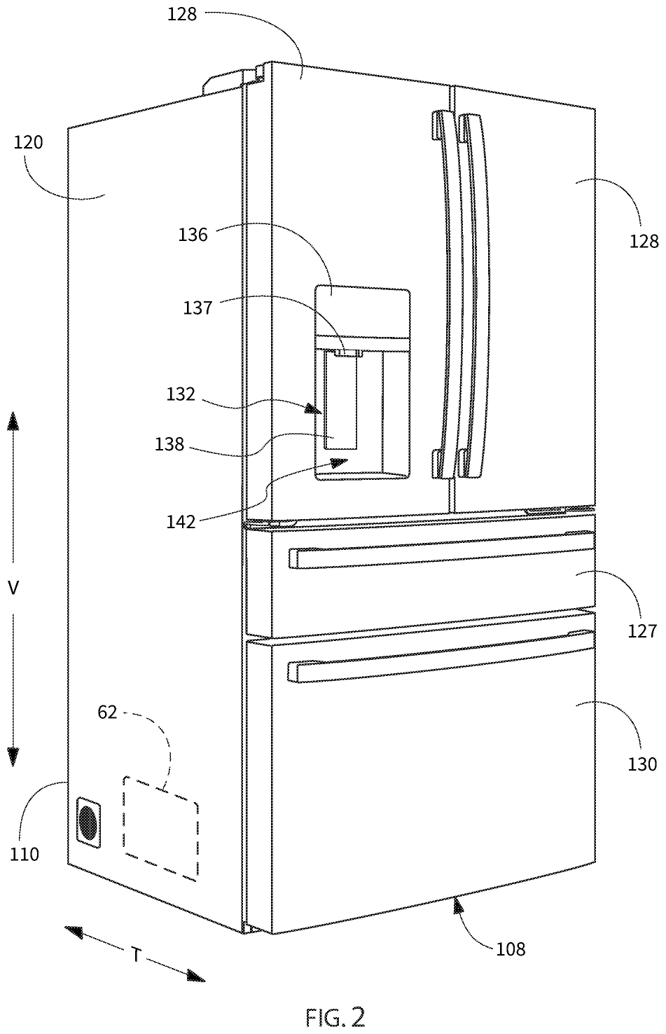

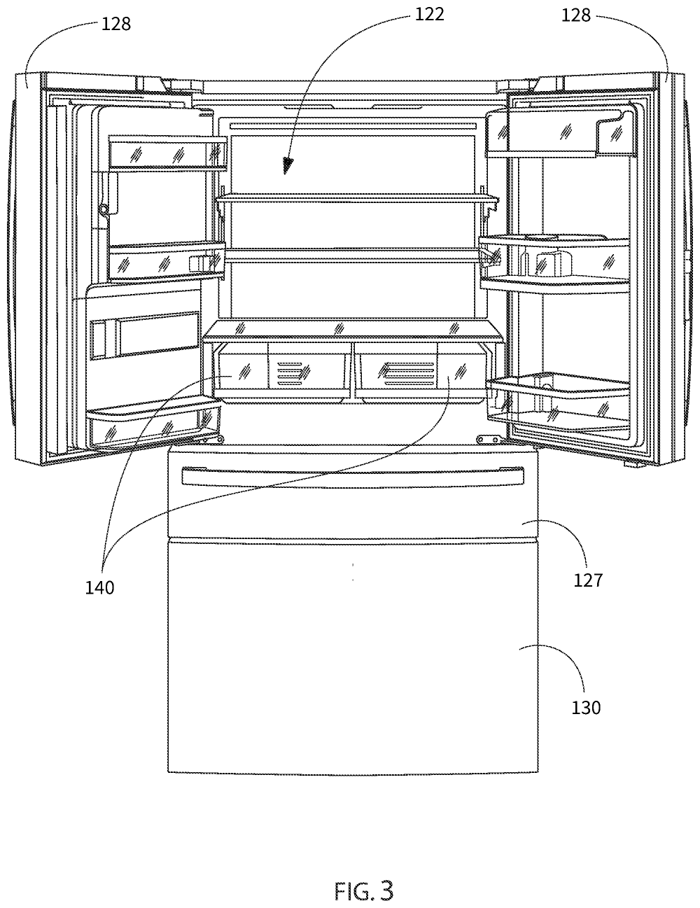

FIG. 1 is a front view of an exemplary embodiment of a household appliance 100, which in the illustrated exemplary embodiment is a refrigerator appliance 100. FIG. 2 is a perspective view of the refrigerator appliance 100 (which, as mentioned, is an embodiment of the household appliance). FIG. 3 is a front view of the refrigerator appliance 100 with fresh food doors 128 thereof in an open position. Refrigerator appliance 100 extends between a top 101 and a bottom 102 along a vertical direction V. Refrigerator appliance 100 also extends between a first side 105 and a second side 106 along a lateral direction L which is perpendicular to the vertical direction V. As shown in FIG. 2, a transverse direction T may additionally be defined perpendicular to the vertical and lateral directions V, L. Refrigerator appliance 100 extends along the transverse direction T between a front portion 108 and a back portion 110.

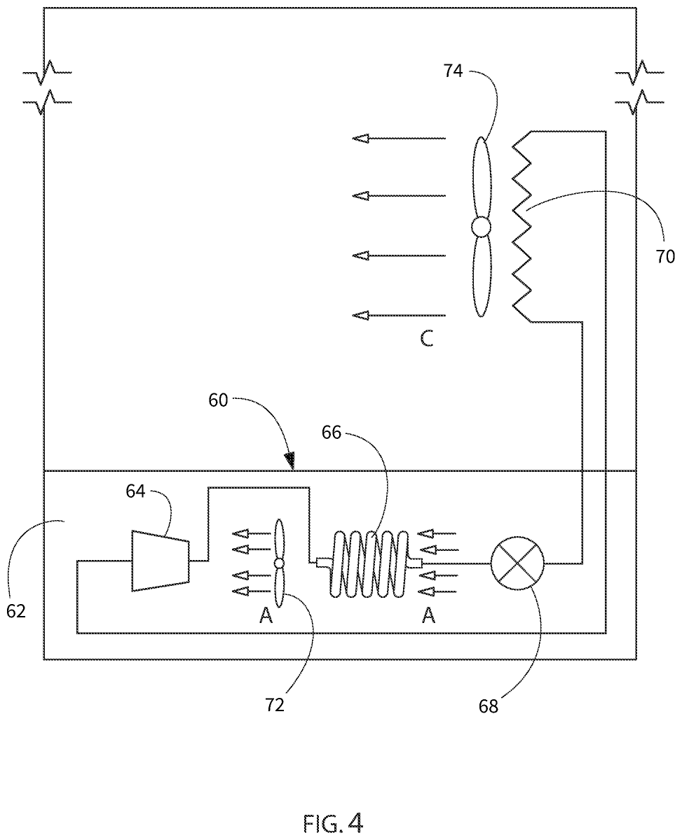

Refrigerator appliance 100 includes a cabinet or housing 120 defining one or more chilled chambers, such as an upper fresh food chamber 122 (FIG. 3) and a lower freezer chamber or frozen food storage chamber 124 (FIG. 1) arranged below the fresh food chamber 122 along the vertical direction V. As used herein, the chambers may be “chilled” in that the chambers are operable at temperatures below room temperature, e.g., less than about seventy-five degrees Fahrenheit (75° F.). An auxiliary food storage chamber may be positioned between the fresh food storage chamber 122 and the frozen food storage chamber 124, e.g., along the vertical direction V. Because the frozen food storage chamber 124 is positioned below the fresh food storage chamber 122, refrigerator appliance 100 is generally referred to as a bottom mount refrigerator. In the exemplary embodiment, housing 120 also defines a mechanical compartment 62 (FIG. 2) for receipt of a sealed cooling system 60 (FIG. 4). Using the teachings disclosed herein, one of skill in the art will understand that the present technology can be used with other types of refrigerators (e.g., side-by-sides) or a freezer appliance as well. Consequently, the description set forth herein is for illustrative purposes only and is not intended to limit the technology in any aspect.

Refrigerator doors 128 are each rotatably hinged to an edge of housing 120 for accessing fresh food chamber 122. It should be noted that while two doors 128 in a “French door” configuration are illustrated, any suitable arrangement of doors utilizing one, two or more doors is within the scope and spirit of the present disclosure. A freezer door 130 is arranged below refrigerator doors 128 for accessing freezer chamber 124. In the exemplary embodiment, freezer door 130 is coupled to a freezer drawer (not shown) slidably mounted within freezer chamber 124. An auxiliary door 127 is coupled to an auxiliary drawer (not shown) which is slidably mounted within an auxiliary chamber (not shown). As may be seen in FIG. 3, a plurality of food storage compartments 140 are disposed within the fresh food storage chamber 122.

Operation of the refrigerator appliance 100 can be regulated by a controller 134 that is operatively coupled to a user interface panel 136. Interface panel 136 provides selections for user manipulation of the operation of refrigerator appliance 100 to modify environmental conditions therein, such as temperature selections, etc. In some embodiments, user interface panel 136 may be proximate a dispenser assembly 132. In response to user manipulation of the user interface panel 136, the controller 134 operates various components of the refrigerator appliance 100. Operation of the refrigerator appliance 100 can be regulated by the controller 134, e.g., controller 134 may regulate operation of various components of the refrigerator appliance 100 in response to programming and/or user manipulation of the user interface panel 136.

As best seen in FIGS. 1 and 2, dispensing assembly 132 includes a dispenser positioned on or mounted to an exterior portion of refrigerator appliance 100, e.g., on an outer surface of one of refrigerator doors 128. The dispenser includes a discharging outlet 137 (FIG. 2) for accessing ice and liquid water. An actuating mechanism 138, shown as a paddle, is mounted below discharging outlet 137 for operating the dispenser. In alternative exemplary embodiments, any suitable actuating mechanism may be used to operate the dispenser. For example, the dispensing assembly 132 can include a sensor (such as an ultrasonic sensor) or a button instead of or in addition to the paddle 138. The user interface panel 136 may provide for controlling the mode of operation of the dispensing assembly 132. For example, user interface panel 136 includes a plurality of user inputs (not labeled), such as a water dispensing button and an ice-dispensing button, for selecting a desired mode of operation such as crushed or non-crushed ice. Additionally, the user inputs may include inputs for selecting one of a plurality of different liquids, such as juice, carbonated water or soda, tea, etc., and/or inputs for selecting a temperature for water to be dispensed, such as chilled, room temperature, or warm, among other possible options.

Discharging outlet 137 and actuating mechanism 138 are an external part of dispenser assembly 132 and are mounted in a dispenser recess 142. Dispenser recess 142 is positioned at a predetermined elevation convenient for a user to access ice or liquids and enabling the user to access the dispensed ice and/or liquids without the need to bend-over and without the need to open refrigerator doors 128. In the exemplary embodiment, dispenser recess 142 is positioned at a level that approximates the chest level of an adult user. According to an exemplary embodiment, the dispensing assembly 132 may receive ice from an icemaker disposed in a sub-compartment of the fresh food chamber 122.

The controller 134 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. It should be noted that controllers 134 as disclosed herein are capable of and may be operable to perform any methods and associated method steps as may be disclosed herein.

The controller 134 may be positioned in a variety of locations throughout refrigerator appliance 100. In the illustrated embodiment, the controller 134 may be located within the door 128. In such an embodiment, input/output (“I/O”) signals may be routed between the controller and various operational components of refrigerator appliance 100. In one embodiment, the user interface panel 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. For example, the user interface 136 may include a touchscreen providing both input and display functionality. The user interface 136 may be in communication with the controller via one or more signal lines or shared communication busses.

Using the teachings disclosed herein, one of skill in the art will understand that the present subject matter can be used with other household appliances, including other types of refrigerators such as a refrigerator/freezer combination, side-by-side, bottom mount, compact, and any other style or model of refrigerator appliance. Additionally, as mentioned above, the household appliance need not necessarily be a refrigerator appliance at all, e.g., the household appliance may be any household appliance having a dispensing system, such as but not limited to an ice maker appliance, a water cooler appliance, or a beverage dispensing system. Accordingly, other configurations of refrigerator appliance 100, or another household appliance entirely, could be provided, it being understood that the configurations shown in the accompanying figures and the description set forth herein are by way of example for illustrative purposes only.

FIG. 4 provides a schematic view of the refrigerator appliance 100, in particular the sealed cooling system 60 thereof. As illustrated in FIG. 4, refrigerator appliance 100 includes a mechanical compartment 62 that at least partially contains components for executing a known vapor compression cycle for cooling air. The components include a compressor 64, a heat exchanger or condenser 66, an expansion device 68, and an evaporator 70 connected in series and charged with a refrigerant. Evaporator 70 is also a type of heat exchanger which transfers heat from air passing over the evaporator to a refrigerant flowing through evaporator 70 thereby causing the refrigerant to vaporize. As such, cooled air C is produced and configured to refrigerate chambers 122 and 124 of refrigerator appliance 100. The cooled air C may be directed to the food storage chambers 122 and 124 by a fan 74.

From evaporator 70, vaporized refrigerant flows to compressor 64, which operates to increase the pressure of the refrigerant. This compression of the refrigerant raises its temperature, which is lowered by passing the gaseous refrigerant through condenser 66 where heat exchange with ambient air takes place so as to cool the refrigerant. A fan 72 is used to pull air across condenser 66, as illustrated by arrows A, so as to provide forced convection for a more rapid and efficient heat exchange between the refrigerant and the ambient air.

Expansion device 68 further reduces the pressure of refrigerant leaving condenser 66 before being fed as a liquid to evaporator 70. Collectively, the vapor compression cycle components in a refrigeration circuit, associated fans, and associated compartments are sometimes referred to as a sealed refrigeration system operable to force cold air through refrigeration chambers 122 and 124. The refrigeration system 60 depicted in FIG. 4 is provided by way of example only. It is within the scope of the present invention for other configurations of the refrigeration system to be used as well. For example, fan 74 may be repositioned so as to push air across evaporator 70, dual evaporators may be used with one or more fans, and numerous other configurations may be applied as well.

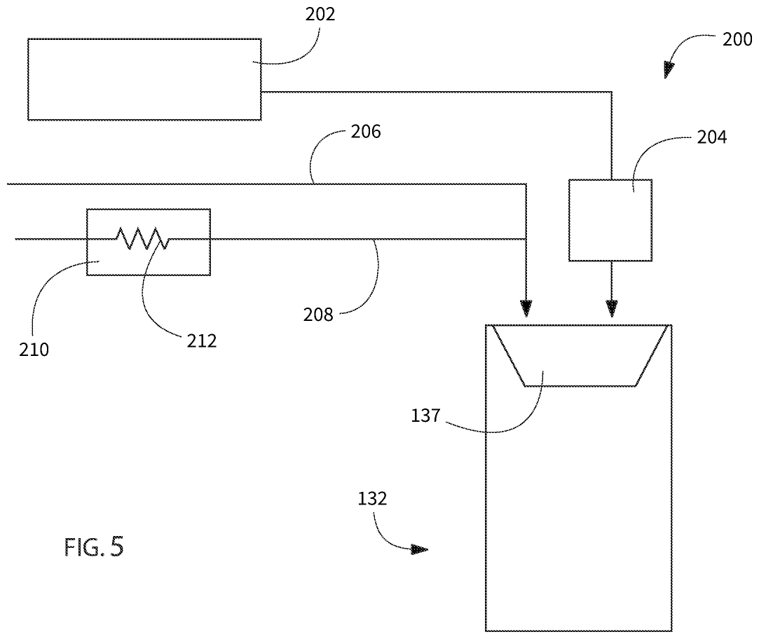

FIG. 5 provides a schematic diagram of a dispenser system 200 which may be incorporated into a household appliance such as refrigerator appliance 100 described above. For example, the dispenser system 200 may include a dispensing assembly, such as the dispensing assembly 132 described above. The dispenser system 200 may further include a plurality of object sources coupled to and in communication with the dispensing assembly 132. For example, the object sources may include sources of liquid objects, e.g., water and/or various other beverages, and/or sources of solid objects, e.g., ice cubes, ice nuggets, ice gems, and/or crushed ice pieces. The object sources may provide such objects to the dispensing assembly 132, e.g., at or through discharging outlet 137.

For example, as illustrated in FIG. 5, the object sources of the dispenser system 200 may include an ice maker 202 which is operable to and configured to form ice pieces of various types, such as ice cubes, nuggets, etc., therein. The ice pieces may be provided from ice maker 202 to the dispensing assembly 132, such as via a crusher 204. Thus, the ice pieces formed in and provided from the ice maker 202 may be delivered to the dispensing assembly whole, e.g., when crusher 204 is not activated, or crushed, e.g., when crusher 204 is activated.

Also illustrated by way of example in FIG. 5 is a plurality of sources of liquid objects, e.g., water, in the dispenser system 200 and coupled to the dispensing assembly 132 of the dispenser system 200. In particular, the illustrated exemplary embodiment of FIG. 5 includes a chilled water line 206 and a heated water line 208. As used herein, the terms “chilled” and “heated” are used with reference to room temperature (where, as noted above, room temperature is generally considered as about seventy-five degrees Fahrenheit (75° F.)) such that “chilled” water includes water below room temperature (such as less than about sixty-eight degrees Fahrenheit (68° F.)) and above freezing such that “chilled water” refers to liquid water, while “heated” water or “hot” water includes water above room temperature (such as greater than about eighty-five degrees Fahrenheit (85° F.)) and below a maximum safe temperature for human consumption, such as at or below about two hundred degrees Fahrenheit (200° F.), such as may be provided for, e.g., brewing tea or coffee. In some embodiments, the hot water line 208 may be coupled to and in fluid communication with (downstream of) a hot water tank 210, where the hot water tank 210 includes one or more heating elements 212 therein, whereby the hot water tank 210 provides heated water to the dispensing assembly 132, e.g., via the heated water line 208.

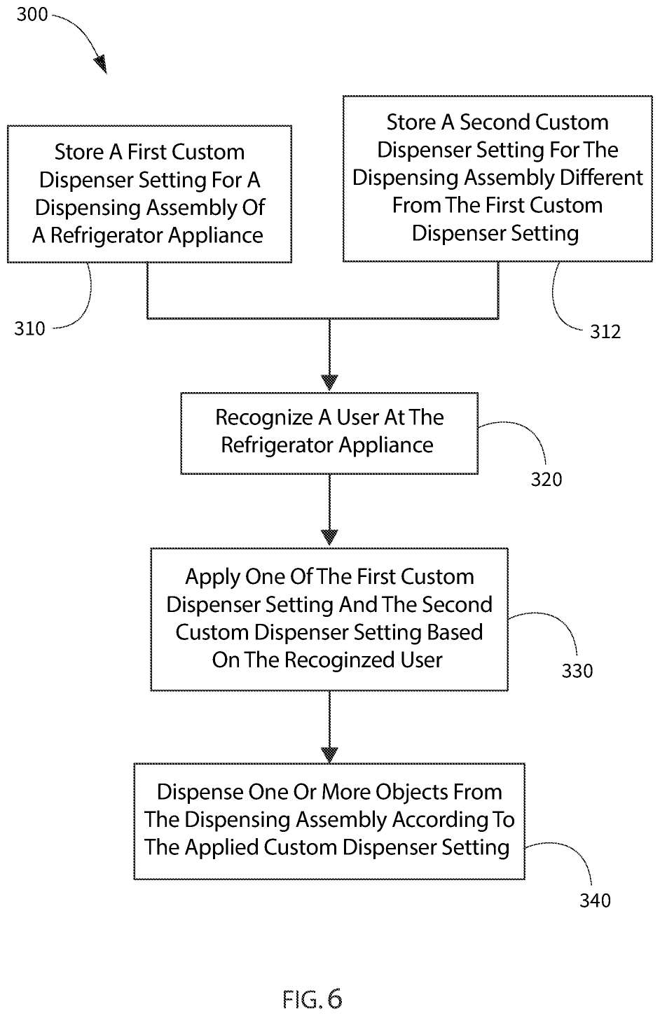

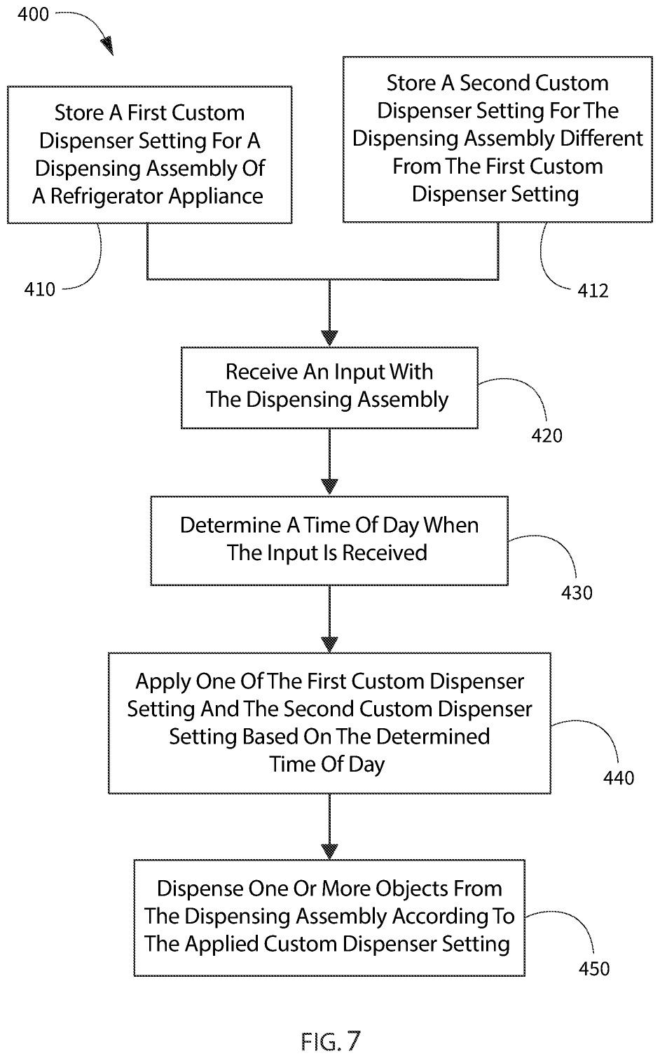

Turning now to FIGS. 6 and 7, embodiments of the present disclosure also include methods of operating a dispenser system of a household appliance, such as dispenser system 200 described above.

As illustrated in FIG. 6, an exemplary method 300 may include a step 310 of storing a first custom dispenser setting for the dispenser system and a step 312 of storing a second custom dispenser setting for the dispenser system. The second custom dispenser setting for the dispenser system maybe different from the first custom dispenser setting. The first custom dispenser setting may be associated with a first user and the second custom dispenser setting may be associated with a second user different from the first user.

The custom dispenser settings may be stored, for example, in a local memory, e.g., of controller 134, and/or in a remote computing device such as a remote database or other computing device with which the household appliance communicates, e.g., via the internet, such as in a cloud computing system or other distributed computing environment. The association of each custom dispenser setting with a respective user may also be stored, e.g., tabulated such as stored in a lookup table, by way of example, locally, remotely, or both, such as in a local memory of the controller and/or in the cloud, as mentioned. For example, the custom dispenser settings may be stored in and/or associated with one or more user profiles or user accounts associated with the household appliance, e.g., in the cloud.

Method 300 may also include a step 320 of recognizing a user at the household appliance, such as a user accessing the dispenser system, e.g., a dispensing assembly thereof, or a user in an area proximate to, e.g., in front of, the household appliance, e.g., refrigerator appliance 100, from which the user is accessing or is likely to access the dispensing assembly 132. For example, a plurality of settings may be stored, such as the first custom dispenser setting and the second custom dispensing setting, and each custom dispenser setting may be associated with a respective user, such as a first user and a second user. In some exemplary embodiments, step 320 may include determining that the recognized user is one of the first user and the second user.

Based on the recognized user, the custom dispenser setting may then be applied or selected, e.g., as illustrated at step 330 of method 300 in FIG. 6. For example, the applied custom dispenser setting may be one of the first custom dispenser setting and the second custom dispensing setting, and may be selected and applied in response to recognizing the associated user, such as applying the second custom dispenser setting when the second user is recognized, for example. The applied custom dispenser setting may be automatically applied, such as without requiring the user to enter a selection input.

Further, method 300 may then include a step 340 of dispensing one or more objects from the dispenser system according to the applied custom dispenser setting. For example, as described above with respect to FIG. 5, the dispenser system may be operable to dispense various objects in various states, such as water at various temperatures or ice pieces either whole or crushed. Thus, for example, the first custom dispenser setting may include crushed ice and chilled water and the second custom dispenser setting may include, also by way of example, heated water. Continuing these examples, the dispenser system may therefore be configured for, and/or methods of operating the dispenser system may include, dispensing crushed ice and chilled water in response to detecting the first user and dispensing heated water in response to detecting the second user.

In some embodiments, the automatically applied custom dispenser settings may also be based on the time, such as the time of day, the day of the week, or a specific date, such as week day or weekend or holidays. The time of day may be a specific time, e.g., down to the minute, or a time range, such as a one-hour time range or a multi-hour time range. The time value may also be a daylong range or a multi-day range, e.g., the automatically applied custom dispenser settings may be based on the time falling within a multi-day range that encompasses a weekend, or a holiday period, etc. In additional embodiments, the time-based automatic custom dispenser settings may be seasonal, e.g., based on a multi-week or multi-month time range, such as dispensing liquid, e.g., liquid water, at a lower temperature or dispensing a different size or quantity of ice during summer months and dispensing the liquid at a higher temperature, or dispensing less ice, etc., during fall or winter months, for example. Thus, for example, method 300 may further include determining a time, such as a date or a time of day, when the user is recognized. In such embodiments, the applied custom dispenser setting may be based on the recognized user and the determined time. For example, heated water may be provided, e.g., dispensed, in the morning, e.g., for brewing tea or coffee, while chilled water may be dispensed in the afternoon.

In some embodiments, method 300 may include, and/or the controller may be configured for, deriving one or more custom dispenser settings from a pattern of usage of the dispenser system. For example, some embodiments may include recognizing, e.g., identifying, a user prior to receiving a selection input (e.g., a chilled water button press) and a dispensing input (e.g., actuating a lever or paddle), and storing the selection, e.g., chilled water. The stored selection may then be associated with the recognized user and a count for the stored selection may be incremented, e.g., increased by one. Multiple stored selections may be associated with the recognized user, and each stored selection may have a corresponding count value. For example, the usage pattern may include defaulting to the stored selection having the greatest count value when the associated user is recognized, e.g., automatically selecting or applying the stored selection having the greatest count value when the user is recognized without the user having to initiate the selection input. In such embodiments, for example, the stored custom setting may be a first custom setting derived from a pattern of usage by a first user, and a second custom setting derived from a second pattern of usage by a second user may also be stored in the same location, e.g., locally and/or remotely, and associated with the second user, e.g., whereby the second custom setting derived from the second pattern of usage is automatically applied upon recognition of the second user.

In some embodiments, the custom dispenser setting may be user-defined, e.g., may be a manually entered favorite or one of multiple preset custom dispenser settings. For example, exemplary methods according to the present disclosure may include receiving the custom dispenser setting via a user input, e.g., directly via an onboard user interface of the household appliance, e.g., refrigerator appliance 100 or via a remote user interface device such as a smartphone, personal computer, etc. In such embodiments, the custom dispenser setting may be received via the user input prior to storing the custom dispenser setting, and then the custom dispenser setting may be stored after having been received from the user input, e.g., defined by the user.

In some embodiments, the user recognition may be based on biometric data associated with the user, such as facial recognition, fingerprint scanning, voice identification, or other similar biometric data, including combinations thereof. For example, the user recognition may be image-based, such as facial recognition, e.g., exemplary methods may include and/or the controller may be configured for image analysis and/or image processing in order to recognize the user. For example, the household appliance may include a camera (still or video), and one or more exemplary methods may include, and/or the controller of the household appliance may be configured for, capturing an image with the camera and detecting the user(s) based on the image captured by the camera. The structure and operation of cameras are understood by those of ordinary skill in the art and, as such, the camera is not specifically illustrated or described in further detail herein for the sake of brevity and clarity. In general, the controller may be operably coupled to the camera for analyzing one or more images obtained by the camera to extract useful information regarding objects or people within the field of view of the camera. In this regard, for example, images obtained by the camera may be used to extract a facial image or other identifying information related to one or more users. Notably, this analysis may be performed locally (e.g., on controller 134) or may be transmitted to a remote server (e.g., in the “cloud,” as those of ordinary skill in the art will recognize as referring to a remote server or database in a distributed computing environment including at least one remote computing device) for analysis. Such analysis is intended to facilitate user detection and recognition, e.g., by identifying a user accessing the household appliance, such as a user who may be operating or accessing the dispenser assembly.

In such embodiments, the controller 134 of the household appliance 100 may be configured for image-based processing, e.g., to detect a user and identify the user. For example, the controller 134 may be configured to identify the user by comparison of the image to a stored image of a known or previously-identified user. For example, controller 134 of household appliance 100 (or any other suitable dedicated controller) may be communicatively coupled to the camera and may be programmed or configured for analyzing the images obtained by the camera, e.g., in order to detect a user accessing or proximate to the household appliance 100 and to identify the user, e.g., recognize the user and load or apply an associated custom dispenser setting for the user, e.g., associated with the recognized user.

In some exemplary embodiments, such methods may include analyzing one or more images to detect and identify a user. It should be appreciated that this analysis may utilize any suitable image analysis techniques, image decomposition, image segmentation, image processing, etc. This analysis may be performed entirely by controller 134, may be offloaded to a remote server (e.g., in the cloud) for analysis, may be analyzed with user assistance, or may be analyzed in any other suitable manner. According to exemplary embodiments of the present subject matter, the analysis may include a machine learning image recognition process.

According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor household appliance 100 and/or a proximate area in front of the household appliance 100 (e.g., an area in which a user is likely to be located when accessing the dispensing assembly). It should be appreciated that this image analysis or processing may be performed locally (e.g., by controller 134) or remotely (e.g., by offloading image data to a remote server or network, e.g., in the cloud).

Specifically, the analysis of the one or more images may include implementation of an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. In a particular example, the reference images may be images of the face or faces of one or more users, such that the extant particular condition in the reference images is the presence of a particular user. Similarities and/or differences between the reference image and the obtained image may be used to extract useful information for improving appliance performance. For example, image differentiation may be used to determine when a pixel level motion metric passes a predetermined motion threshold.

The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image (the term “object” is used broadly in this context to include humans, e.g., users of the household appliance 100). In addition, or alternatively, the image processing algorithms may use other suitable techniques for recognizing or identifying particular items or objects, such as edge matching, divide-and-conquer searching, greyscale matching, histograms of receptive field responses, or another suitable routine (e.g., executed at the controller 134 based on one or more captured images from one or more cameras). Other image processing techniques are possible and within the scope of the present subject matter.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object (e.g., a human face, such as the face of a user of household appliance 100) or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the steps of detecting and identifying a user may include analyzing the one or more images using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described methods or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners, such as by different users. This training data may be stored locally or remotely and may be communicated to a remote server for training other appliances and models.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

In some embodiments, the user may also or instead be recognized based on a container, e.g., cup, mug, drinking vessel, or other similar container, placed within a dispenser recess of the dispenser system. In various embodiments, the container may be recognized using one or more of an ultrasonic signature of the container, an embedded chip in the container, a radio frequency identification (RFID) tag on the container, or by the weight of the container. As another example, in some embodiments, the container may also or instead be recognized using a camera and performing image analysis and/or image processing on an image of the container obtained with the camera, in a similar manner as described above with respect to the user recognition, e.g., facial recognition.

In some embodiments, the user may also or instead be recognized by detecting a remote user interface device associated with the user, such as recognizing the user based on a signal from a remote user interface device such as a smartphone or smartwatch. The remote user interface device may be a smartphone, tablet, personal computer, wearable device (e.g., smartwatch), smart speaker (e.g., a user may be recognized based on a voice command from the user which is received by the smart speaker, and the smart speaker then transmits a signal to the household appliance 100), smart home system, and/or various other suitable devices. The household appliance 100 may be in communication with the remote user interface device through various possible communication connections and interfaces. The household appliance 100 and the remote user interface device may be matched in wireless communication, e.g., connected to the same wireless network. The household appliance 100 may communicate with the remote user interface device via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the household appliance 100 and the remote user interface device. For example, BLUETOOTH® Low Energy may advantageously minimize the power consumed by the exemplary methods and devices described herein due to the low power networking protocol of BLUETOOTH® Low Energy. As another example, BLUETOOTH® Low Energy is more accurate than GPS and may provide fine grained location (e.g., accurate within inches) and distance from household appliance 100, e.g., based on a received signal strength indicator.

The remote user interface device is “remote” at least in that it is spaced apart from and not physically connected to the household appliance 100, e.g., the remote user interface device is a separate, stand-alone device from the household appliance 100 which communicates with the household appliance 100 wirelessly. Any suitable device separate from the household appliance 100 that is configured to provide and/or receive communications, information, data, or commands from a user may serve as the remote user interface device. For example, the remote user interface device may be a smartphone operable to store and run applications, also known as “apps,” and some or all of the method steps disclosed herein may be performed by a smartphone app.

In some embodiments, exemplary methods of the present disclosure may also include one or more anticipatory steps or compensatory steps in order to meet the applied custom dispenser setting, such as anticipatory steps prior to dispensing the one or more objects from the dispenser system and/or compensatory steps after dispensing the one or more objects from the dispenser system. For example, when a usage pattern derived from usage by the recognized user indicates a large volume of ice may be desired (such as based on a pattern of activation times of the dispensing system while dispensing ice to a particular user), the method may include adjusting a speed of a compressor (e.g., compressor 64 illustrated in FIG. 4) of the household appliance in response to the recognized user, such as increasing the compressor speed in order to provide increased production of cooled air C at the evaporator 70 and more rapid ice production in order to help provide or replenish the large volume of ice. As another example, when a stored custom dispenser setting associated with a user includes heated water, exemplary methods may include activating a heater (e.g., heating element 212 illustrated in FIG. 5) of the dispenser system in response to the recognized user.

Another exemplary method 400 of operating a dispenser system of a household appliance is illustrated in FIG. 7. The method 400 may include storing at least one custom dispenser setting, such as a step 410 of storing a first custom dispenser setting and a step 412 of storing a second custom dispenser setting for the dispenser system. The second custom dispenser setting may be different from the first custom dispenser setting. Also, the first custom dispenser setting may be associated with a first user, and the second custom dispenser setting may be associated with a second user different from the first user.

In some embodiments, exemplary methods according to the present disclosure, such as method 400 illustrated in FIG. 7 may include an input step, such as a dispensing input (e.g., actuating a lever or paddle), e.g., step 420 of receiving an input with the dispenser system. Still referring to FIG. 7, method 400 may also include determining a time when the input is received. As discussed above, the time may be a time of day, or a day, or may include determining that the time falls within a larger range, such as a multi-day range, a multi-week range, or a multi-month range. In the example illustrated in FIG. 7, the determined time is a time of day. The time of day may be a specific time, e.g., down to the minute, or a time range, such as a one-hour time range or a multi-hour time range.

Method 400 may further include a step 440 of applying the custom dispenser setting based on the determined time, e.g., the determined time of day in the example illustrated in FIG. 7. For example, the applied custom dispenser setting may be one of the first custom dispenser setting and the second custom dispenser setting, such as the first custom dispenser setting may be applied when the input is received at or during a first time of day and the second custom dispenser setting may be applied when the input is received at or during a second time of day. Method 400 may also include a step 450 of dispensing one or more objects from the dispenser system according to the applied custom dispenser setting. Thus, in exemplary methods such as method 400 which include determining a time of day, the applied custom dispenser setting may be based on the determined time of day. For example, heated water may be provided, e.g., dispensed, in the morning, e.g., for brewing tea or coffee, while chilled water may be dispensed in the afternoon.

Those of ordinary skill in the art will recognize that the various steps of the exemplary methods described herein may be combined in various ways to arrive at additional embodiments within the scope of the present disclosure. For example, method 400 may also include recognizing a user at the household appliance, e.g., similarly to the user recognition described above with respect to method 300. Thus, in method 400, the applied custom dispenser setting at step 440 may be based on the recognized user and the determined time, e.g., time of day, or day, or larger time range.

As another example, in embodiments which include user recognition, the method 400 may include recognizing the user based on a container placed within a dispenser recess of the dispenser system, based on biometric data associated with the user, by detecting a remote user interface device associated with the user, and/or combinations thereof, as described above.

In a further example, method 400 may also include similar anticipatory steps or compensatory steps as described above with respect to method 300, whereas in method 400 such steps may be performed based on the determined time. For example, a usage pattern may indicate a call for a large quantity of ice typically occurs in the mid-afternoon, (or in the summer and spring versus fall and winter, as discussed above) such that when the determined time falls within the usage pattern corresponding to a large quantity of ice, e.g., when the determined time is a time of day in the mid-afternoon or is a time within a warmer part of the year (e.g., summer), etc., method 400 may include a step of adjusting, e.g., increasing, a speed of a compressor of the household appliance based on the determined time. As another example, method 400 may include a step of activating a heater of the dispenser system based on the determined time, such as activating the heating element 212 (FIG. 5) to provide heated water when the determined time is a time of day in the morning, such as to brew coffee or tea, or is a time within the colder part of the year, e.g., winter, for example.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a dispenser system of a household appliance, the method comprising:
storing a custom dispenser setting for the dispenser system;
recognizing a user at the refrigerator appliance;
applying the custom dispenser setting based on the recognized user; and
dispensing one or more objects from the dispenser system according to the applied custom dispenser setting.

2. The method of claim 1, further comprising determining a time when the user is recognized, wherein the applied custom dispenser setting is based on the recognized user and the determined time.

3. The method of claim 1, further comprising, prior to storing the custom dispenser setting, deriving the custom dispenser setting from a pattern of usage of the dispenser system.

4. The method of claim 1, further comprising, prior to storing the custom dispenser setting, receiving the custom dispenser setting via a user input.

5. The method of claim 1, wherein the step of recognizing the user comprises recognizing the user based on a container placed within a dispenser recess of the dispenser system.

6. The method of claim 1, wherein the step of recognizing the user comprises recognizing the user based on biometric data associated with the user.

7. The method of claim 1, wherein the step of recognizing the user comprises recognizing the user by detecting a remote user interface device associated with the user.

8. The method of claim 1, further comprising activating a heater of the dispenser system in response to the recognized user.

9. The method of claim 1, further comprising adjusting a speed of a compressor of the refrigerator appliance in response to the recognized user.

10. The method of claim 1, wherein the custom dispenser setting is a first custom dispenser setting associated with a first user, further comprising storing a second custom dispenser setting for the dispenser system different from the first custom dispenser setting, the second custom dispenser setting associated with a second user, wherein the step of recognizing the user at the refrigerator appliance comprises determining that the recognized user is one of the first user and the second user, and wherein the step of applying the custom dispenser setting comprises applying the first custom dispenser setting when the recognized user is the first user and applying the second custom dispenser setting when the recognized user is the second user.

11. A method of operating a dispenser system of a household appliance, the method comprising:
storing a custom dispenser setting for the dispenser system;
receiving an input with the dispenser system;
determining a time when the input is received;
applying the custom dispenser setting based on the determined time; and
dispensing one or more objects from the dispenser system according to the applied custom dispenser setting.

12. The method of claim 11, further comprising recognizing a user at the refrigerator appliance, wherein the applied custom dispenser setting is based on the recognized user and the determined time.

13. The method of claim 12, wherein the step of recognizing the user comprises recognizing the user based on a container placed within a dispenser recess of the dispenser system.

14. The method of claim 12, wherein the step of recognizing the user comprises recognizing the user based on biometric data associated with the user.

15. The method of claim 12, wherein the step of recognizing the user comprises recognizing the user by detecting a remote user interface device associated with the user.

16. The method of claim 11, further comprising, prior to storing the custom dispenser setting, deriving the custom dispenser setting from a pattern of usage of the dispenser system.

17. The method of claim 11, further comprising, prior to storing the custom dispenser setting, receiving the custom dispenser setting via a user input.

18. The method of claim 11, further comprising activating a heater of the dispenser system based on the determined time.

19. The method of claim 11, further comprising adjusting a speed of a compressor of the refrigerator appliance based on the determined time.

20. The method of claim 11, wherein the custom dispenser setting is a first custom dispenser setting associated with a first time, further comprising storing a second custom dispenser setting for the dispenser system different from the first custom dispenser setting, the second custom dispenser setting associated with a second time, and wherein the step of applying the custom dispenser setting comprises applying the first custom dispenser setting when the determined time is the first time and applying the second custom dispenser setting when the determined time of day is the second time.
